(19) United States
(12) Patent Application Publication
(10) Pub. No.: US 2015/0339888 A1
(43) Pub. Date: Nov. 26, 2015

(54) WAGERING KIOSK SYSTEM

(71) Applicant: Station Casinos LLC, Las Vegas, NV (US)

(72) Inventors: Abraham Y. Hong, Las Vegas, NV (US); Jon R. Von Tobel, Las Vegas, NV (US); John F. Vidmar, Las Vegas, NV (US)

(73) Assignee: Station Casinos LLC, Las Vegas, NV (US)

(21) Appl. No.: 14/284,308

(22) Filed: May 21, 2014

(51) Int. Cl. G07F 17/32

(52) U.S. Cl. CPC G07F 17/3248

(57) ABSTRACT

A wagering kiosk is disclosed which may be used for opening a player wagering account, a player loyalty account and for placing a sports book wager in a gaming establishment.

### TECHNICAL FIELD

Embodiments disclosed herein relate generally to kiosks for wagering and account signup. More particularly, the embodiments relate to kiosks that make wagering and account signup more convenient thus enhancing player usage in a gaming establishment such as a casino.

### BACKGROUND

Wagering has been popular for centuries. In more recent times, gaming establishments such as casinos have sought to improve the gaming experience for customers. In order to make the experience more rewarding, many gaming establishments have implemented user loyalty programs such as those successfully employed by airlines and other industries. Such programs allow a user to accumulate points based upon repeated purchases or utilization of the services of the provider. These programs improve user loyalty by allowing those users to redeem points earned by purchases to purchase other goods and/or services of the provider. For example, points earned during gaming sessions may be redeemed for dining, drinking, spas, rides and shows in the gaming establishment. These additional entertainment activities are very popular and have thus become increasing available in gaming establishments as a method to attract additional player activity.

The financial success of a gaming establishment such as a casino is directly tied to its ability to attract customers. Accordingly, casino operators have sought ways such as by incentives in which to attract more players. One effective method to attract additional players is to provide those players with a more convenient, rewarding and lucrative player reward program as mentioned above. However, because many gaming establishments now offer such reward programs, it is necessary and desirable to make those programs easier to use and more lucrative. Such improvements enhance the experience for the players and provide the gaming establishment with a competitive advantage over other gaming establishments with similar customer reward programs.

Gaming systems employing user loyalty programs have a central information network, which may be a wired or a wireless network, to which various devices, including gaming machines, may be connected. Player activity may be tracked at the gaming machines during regular gaming sessions. Data is transmitted to the central location for accumulating and tracking player points in a player account file of a central database. Gaming sessions may begin upon player card insertion. For example, upon insertion of a player card into a gaming machine a session is established and player reward points will accrue in the player's account depending upon various factors including the amount of money inserted into the machine during the gaming session or the amount of time the player spends wagering during the gaming session.

As stated above, upon insertion of a player card into a first type of gaming such as, for example, a slot machine or video poker or other gaming machine as is generally known in the gaming arts, a gaming session is established and the player's identity is recognized by the computer reading the information from the player card. Once the player's identity is known, the network information software can track that player's use of the card in various machines and credit the player's account for player points earned during the player's visit to the gaming establishment. In this manner, the gaming establishment can track level and frequency of player activity during a gaming session as well as the wagered amount and the number of gaming sessions during a particular calendar period. The history of the player's wagering, whether successful or unsuccessful, may also be tracked.

The same player card may be used to earn loyalty points at other types of gaming activity in the gaming establishment. For example, the player card may be presented at the second type of gaming activity such as a sports book counter when the player is wagering on sporting events and points can be accumulated by the player for that activity. As with the gaming machines, information on the player's frequency and level of activity may be useful to the gaming establishment. Points accumulated during this sports wagering activity is also valuable to the player as he or she may accumulate reward points which may be redeemed by that player to purchase additional gaming, meals or other discounted activities or merchandise which is offered by that gaming establishment to its customers. These player cards may also be presented at a cashier's cage at the gaming establishment when a player purchases chips to play at a table game. As with the sports book and gaming machines, this rewards the player as well as providing useful information to the gaming establishment.

Other types of conveniences for players have been introduced by some wagering establishments. For example, these establishments have instituted player wagering accounts, especially useful and convenient for players wagering in the race and sports betting venues. These accounts allow a player to maintain an account balance and make wagers from that account balance. This type of wagering may be done remotely through the internet (where authorized) or through the use of smartphones or other portable electronic devices connected to the establishment intranet as discussed below. The player may view account balance, wagering history and currently pending wagers at any time.

While suitable for its intended purpose, accounts for player loyalty programs and race and sports wagering may sometimes be difficult or time consuming to open. For example, most of these programs require an in-person signup at a counter in the gaming establishment. Depending upon the time of day or other usage factors, including popularity of the program, there may be long lines at the counter or other delays. In addition, the sign up counters may only be open during certain hours of the day making it inconvenient for some players to sign up. Delays and difficulties in signing up may discourage some players from signing up for such programs thereby defeating a primary purpose of the program.

Sports book betting operations in a gaming establishment, as mentioned above, have become more popular in recent years as interest in sports has also increased. Most gaming establishments today have a sports book type of gaming venue at a location in the casino. Generally, these venues include a large screen indicating teams and point spreads as well as traditional horse racing and other types of wagering information. Numerous television screens are located at various positions to allow the players to view the various events they may wager on. Sports books generally include a betting counter at which various casino employees may input wagers from various players and provide those players with tickets indicating the wager, both type and amount. These sports book operations have become so popular that, many times, there are lines which require the player to wait in order to place a wager. Not only may this be inconvenient, but when the start of the event (e.g. horse race or other sporting event) is near, it may be stressful for the player as he or she may be unsure whether or not he/she will be able to place the wager down prior to the start of the event.

In order to make it more convenient for players to bet at the sports book, in recent years, sports book operations have permitted players to use electronic handheld devices to place wagers as is known in the art. A player may input his or her wagering information through a keypad on a handheld device. All debits and credits to his or her account are made electronically through the gaming establishment network as is also known in the art. This type of electronic wagering is available through a wide area wireless network on the premises of the gaming establishment. In addition to allowing the player to place a wager without waiting in a queue at the sports book, this type of wagering provides player privacy and account security as well as a 24/7 opportunity for wagering. Because sports books are operated by casino employees, they are generally not open 24/7 so players would otherwise be required to place their wagers only during operating hours.

An interactive kiosk is a computer terminal featuring specialized hardware and software designed within a public venue that provides access to information and applications for communication, commerce, entertainment, and education. Interactive kiosks sometimes resembled telephone booths, but can also be used while sitting on a bench or chair. Interactive kiosks are typically placed in high foot traffic settings such as hotel or casino lobbies or airports. Integration of technology allows kiosks to perform a wide range of functions, evolving into self-service kiosks. For example, kiosks may enable users to enter a public utility bill account number in order to perform an online transaction, or collect cash in exchange for merchandise. Customized components such as coin hoppers, bill acceptors, card readers and thermal printers enable kiosks to meet the user's specialized needs.

It would be desirable to have both player loyalty card and race/sports wagering account signups made easier. It would also be desirable to enable race and sports book wagering without the need to interact face to face with cashiers or other personnel of the gaming establishment. In addition, by automating such signup and wagering, the players would be able to access the system 24/7/365 and not be subject to operating hours of the signup location. Such a system would increase player utilization of wagering venues and thereby provide an advantage to the gaming establishment. In addition, while handheld devices are useful for improving sports book betting usage, not all players have access to such devices. By providing a device for automated player loyalty card and wagering account signup and making it easier to place a wager on a sports or other event without waiting in line or being subject to operating hours of the sports book, a casino would be able to improve the player experience and satisfaction and thus be able to gain a competitive advantage.

### SUMMARY

A wagering kiosk is disclosed which provides for automated signup for player loyalty card and race/sports wagering accounts as well as sports book access to place wagers. The kiosk includes capability to interactively engage with the kiosk through a video screen and/or an audio system to input all required information for player card and race/sports wagering account signup. The kiosk also includes the capability to provide sports book wagering access. Thus, a player may place a wager without the need to wait in line and without the need to interact face to face with an employee of the gaming establishment. This may be important to some players who are not comfortable with such interactions in a gaming environment. Interactive features on the kiosk allow communication with an employee of the gaming establishment through audio/visual capabilities on the kiosk to enable player sign up for loyalty card or race/sports book wagering accounts. In addition, because the kiosk is available 24/7/365, a player wishing to sign up for a player loyalty card or sports wagering account or to place a wager at a sports book is not limited by gaming establishment operating hours or counter personnel availability for engaging in any of those activities.

### BRIEF DESCRIPTION OF THE FIGURES

FIG. 1 is a perspective view of a kiosk in accordance with one embodiment;

FIG. 2 is a perspective view of a sports book venue at a gaming establishment;

FIG. 3 is a perspective view of a slot machine;

FIG. 4 is a block diagram of a gaming system network;

FIG. 5 is a flow chart of a player loyalty account signup sequence;

FIG. 6 is a flow chart of a player wagering account signup sequence; and

FIG. 7 is a flow chart of a sports book wagering transaction on a kiosk.

### TECHNICAL DESCRIPTION

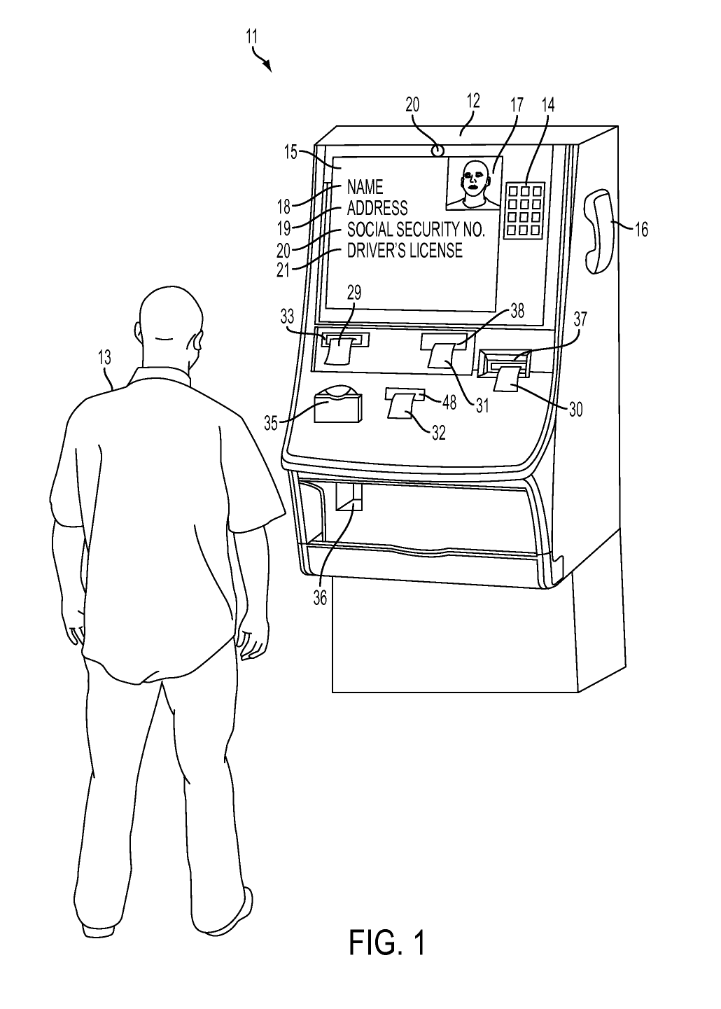

Referring to the figures wherein like reference numerals denote like structure throughout each of the various figures, FIG. 1 illustrates a wagering kiosk 11. Kiosk 11 includes a housing 12. A player 13 may interact with kiosk 11 through a keypad 14 and may receive information on a screen 15 which may, in one embodiment, be a touchscreen. Thus, player 13 may input information through keypad 14 or touchscreen 15. A telephone receiver 16 may be used by player 13 to speak with a gaming establishment employee such as a solutions center employee who is remote but whose image may appear on a portion 17 of screen 15. In one embodiment, kiosk 11 may include the capability for player 13 to enroll in a player loyalty reward account program. In another embodiment, player 13 may establish a race/sports wagering account. In order to establish such accounts, player 13 is prompted to input personal information such as name 18, address, 19, social security number 20 and driver's license number 21 through keypad 14 or touchscreen 15 into the gaming establishment computer network as prompted on touchscreen 15 in an interactive mode. Player 13 may choose to have some or all of this information restricted from view for privacy or security purposes. Player 13 interacts through screen 15 and telephone handset 16 with an employee of the gaming establishment whose image is shown on screen portion 17 as will be described in more detail below. An image of player 13 taken by a still or video camera 20 on kiosk 11 may be transmitted to the employee as will be described below.

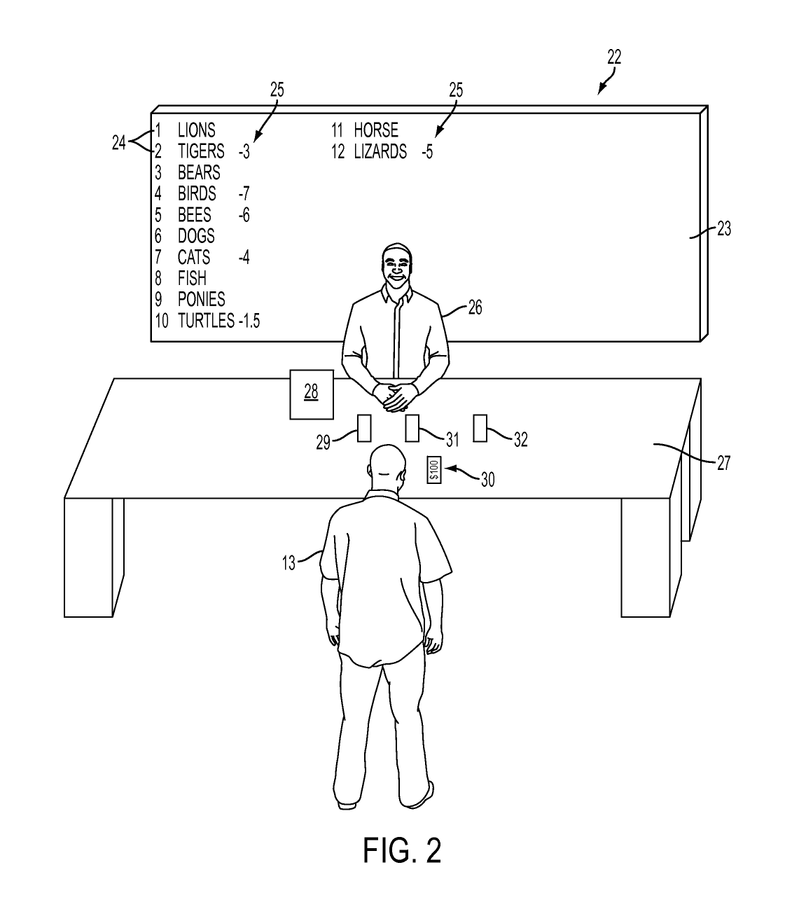

Referring to FIG. 2, a wagering venue is illustrated. This type of gaming is commonly referred to as a race and sports book 22 for wagering on horse racing, sporting or other events as determined by the gaming establishment. Sports book 22 generally includes a display screen 23 for indicating the teams playing 24 and the odds or point spreads 25 for that game. The teams playing are generally indicated by a number (1-12 shown in FIG. 2) and the point spreads 25 are indicated by a negative sign and a number adjacent to the favored team. As an example, the Lions (#1) may be playing the Tigers (#2) with the Tigers favored by 3 points as shown in FIG. 2. The Bears (#3) are playing the birds (#4) with the Birds favored by seven points in another possible wager. Team #5 Bees is favored by 6 points over team #6 Dogs by 6 points and so on. In order to place a wager, player 13 approaches counter 27 and communicates to sports book attendant 26 which wager he or she desires to make. In the case of the Lions and Tigers game example, player 13 states to attendant 26 that he or she wishes to wager on #2 (Tigers) for one hundred dollars. Attendant 26 then enters this information in terminal 28 and takes the amount of the wager in the form of cash ($100 bill) 30 from player 13. Cashier 26 issues a WIN (Wagering Information Network) ticket 31 to player 13 indicating that a wager in the amount of one hundred dollars has been made on the Tigers minus 3 in that game. This type of sports book wagering is known in the gaming art.

In one embodiment of the disclosure, at the time of making the one hundred dollar wager referred to above, player 13 gives cashier 26 a player card 29 which cashier 26 inserts into terminal 28 and which is read in terminal 28. Because player 13 has a loyalty card 29, his loyalty account is credited with points as determined by the gaming establishment for a one hundred dollar wager. In one embodiment, the loyalty account may also include player funds which may be used to wager. In another embodiment, if player 13 has a race/sports wagering account, the one hundred dollar amount of the wager on the Tigers placed by player 13 may be deducted from player 13's account balance by attendant 26 though terminal 28. In that embodiment, player 13 indicates to attendant 26 his race/sports account wagering number and provides appropriate identification and the wager is funded. In another embodiment player 13 hands attendant 26 a TITO (Ticket In Ticket Out) voucher 32 which player 13 had received from a gaming machine such as a slot machine or a video poker machine. In either of these embodiments, player 13 receives a WIN ticket 31 indicating the wager (#2 Tigers) and the amount of the wager (one hundred dollars) as was described above. A successful WIN ticket 31 and TITO voucher 32 may be redeemed at different types of gaming venues in the gaming establishment or used to fund wagering credits at various gaming venues as will be described herein.

In another embodiment, referring to FIG. 1, kiosk 11 may include the capability to wager as though player 13 was present at race/sports book 22. Kiosk 11 may be positioned at various convenient locations throughout the gaming establishment. Kiosk 11 is connected through a wireless or hardwired network to a central computer as described below such that the player information is available at kiosk 11. Kiosk 11, in one embodiment, accepts player card 29 in magnetic card reader/scanner 33. The information on the magnetic strip of card 29 is read by reader 33 and the player name 18, as well as the account number, point balance and account balance may be displayed on screen 15 in FIG. 1. Player 13 may insert card 29 into card reader 33 and enter the passcode or other security measure on keypad 14 or touchscreen 15. The player 13 may then use keypad 14 or touchscreen 15 to select a wager (#2 Tigers) as described above when player 13 was present at race sports book 22. As with the embodiment described with respect to FIG. 2, player 13 is issued WIN ticket 31 from a printer 48 indicating the wager (#2 Tiger) and the amount of the wager (one hundred dollars). In an alternate embodiment, card reader 33 may also read credit card information such that a credit or debit card could be used by a player 13 in order to fund a sports wager or to add money to his or her sports wagering account balance as will be described below.

Kiosk 11 provides players with an opportunity for a gaming experience in a near cashless manner by accepting ticket-in/ticket-out (TITO) vouchers 32, WIN tickets 31 or by debiting wagering or loyalty card account balances to establish a wagering credit enabling player 13 to place a wager. In one embodiment, kiosk 11 may also include the ability to accept coins in coin acceptor 35 and to dispense coins from coin dispenser 36. In another embodiment, kiosk 11 may include the ability to accept or dispense cash 30 through bill acceptor/dispenser/validator 37 such that player 13 may choose to withdraw all of some of the balance of his or her account at any time at kiosk 11. Player 13 may also choose to add cash to fund his or her account or place a wager through bill acceptor 37 and coin acceptor 35. In one embodiment, kiosk 11 also includes the ability to incorporate utilization of TITO vouchers 32 and successful WIN tickets 31 such that players 13 will be able to fund their wagering or loyalty account (and wagers if they do not have an account) with cash, TITO vouchers 32 from other gaming venues, and from successful WIN tickets 31, as well as to add/withdraw monies to/from player 13's wagering or loyalty account if he or she has one.

Kiosk 11 will accept funded sports wagers from both rated and unrated/anonymous players in addition to card account holders. A rated player is one who has been pre-approved and has established a loyalty account and who may also have a race/sports wagering account. Unrated/anonymous players are those who neither have a race and sports wagering account nor a player's loyalty card. For, example, in one embodiment, successful (winning) WIN tickets 31 may be inserted into optical mark recognition device (OMR) 38 to fund the players race/sports account or to fund another race/sports wager on kiosk 11. If used to fund a player's race/sports wagering account, that balance may then be used in a wagering session in another gaming venue such as a slot machine or video poker or other gaming machine as will be described herein.

In one embodiment, if player 13 has a race/sports book wagering account and/or loyalty account, winning account wagers from other gaming venues in the gaming establishment may be paid directly to the player's race/sports wagering account or loyalty account. In some embodiments, player 13 must open a loyalty account in order to open a wagering account. In the event of an unrated/anonymous player (with no loyalty or wagering account), who wishes to place a sports book wager on kiosk 11, cash may be inserted by player 13 in bill acceptor 37 and/or coin acceptor 35 and a wager placed as described above. Of course, a successful WIN ticket 31 or a TITO ticket 32 could also be used by an anonymous player to fund a wager by inserting WIN ticket 31 into OMR 38 or TITO ticket 32 into validator/acceptor 37. After placing the wager, a WIN ticket 31 is issued which can be redeemed at various venues (i.e. kiosk 11, sports book 22, cashier's cage or over the counter) in the gaming establishment in the event that the wager is successful. For example, WIN tickets 31 could be redeemed at various kiosks 11 in the gaming establishment or at cashier's windows for cash or players chips to be used at a table game such as blackjack or poker. WIN tickets 31 could also be redeemed at a sports book 22 for cash or as a credit to place another wager. As described above, a credit or debit card could, in one embodiment, be inserted into card reader 33 in order to fund a sports book wager.

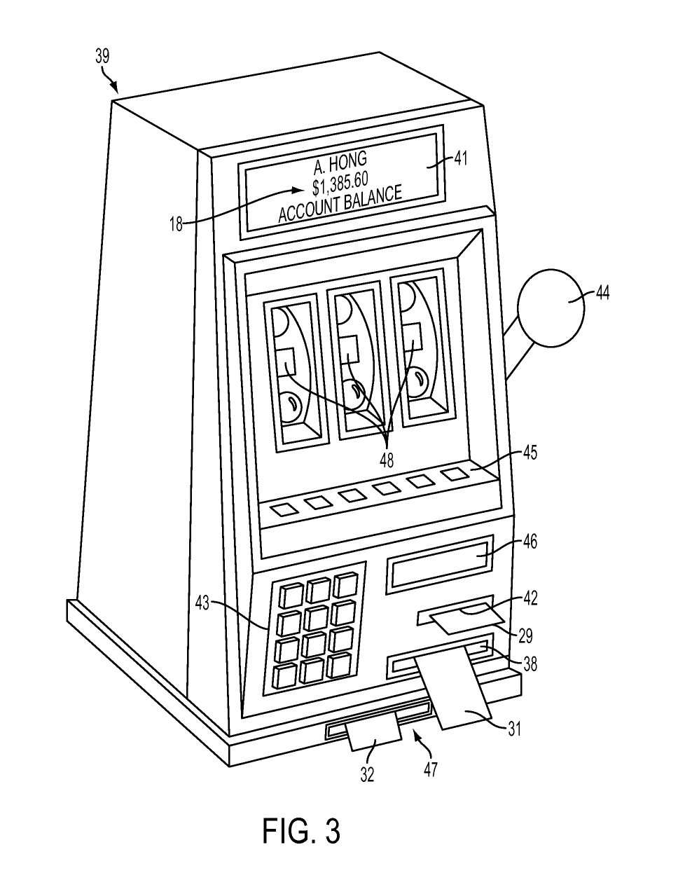

Referring to FIG. 3, a gaming machine is illustrated which may include a slot machine 39 which includes a display screen 41 which, in one embodiment, may indicate player information 18 such as the name of the player 13 and that player's account balance if the player has either a wagering or loyalty account with points balance if player 13 has a player's loyalty account card 29. For reasons of privacy, a player may choose an option such that information may or may not be displayed on screen 41. In one embodiment, slot machine 39 includes a magnetic card reader 42 into which a player loyalty card 29 may be inserted. Card 29 may be retained in card reader 42 until the gaming session is complete or card 29 may be swiped through card reader 42 such that the magnetic strip (not shown) on card 29 is read by card reader 42 as is known in the art. Reading information from card 29 by card reader 42 provides the information displayed on display screen 41. For security purposes, player 13 may be asked to input a passcode through the use of keypad 43. Player 13 may initiate play on slot machine 39 by pulling handle 44 or pressing betting keys 45 as is well known in the gaming art.

If player 13 has a wagering account, in one embodiment, he will be asked to log onto the account by entering the player account number and PIN code through keypad 43 and/or screen 41 which may, in one embodiment, be a touchscreen. If player 13 accesses his wagering or loyalty account, a balance 18 may be indicated on screen 41 as is shown. Player 13 may then make wagers on a gaming machine which may be slot machine 39 from that wagering account. If player 13 does not have a wagering account at the gaming establishment, he may choose to wager on slot machine 39 as described below.

In one embodiment, if player 13 does not have a wagering or loyalty account and wishes to make a wager on slot machine 39, player 13 may choose to input cash into bill validator 46 or he or she may choose to wager from a TITO voucher 32 which may also be inserted into validator/acceptor 46. When cash is inserted into cash validator 46 or a TITO voucher 32 is inserted into validator 46, the amount inserted is reflected on screen 41 as a wagering credit balance 18. In another embodiment, player 13 may choose to place a wager by drawing from the account balance indicated on screen 41 from a wagering or loyalty account which is accessed by inserting loyalty card 29 into card reader 42 or by entering a wagering account number and PIN. In any event, player 13 makes a wager and plays slot machine 39 by pulling handle 44 or pressing wagering buttons 45 depending upon the type of slot machine or the player's preference. Upon pulling handle 44, the amount of the wager selected by the player 13 is deducted from the wagering account credit 18 shown on screen 41 or if the player has wagered using cash, WIN ticket or a TITO, from the wagering credit balance inserted into the machine 39. Upon playing slot machine 39, the matching icons visible in windows 48 indicate whether player 13 has won or lost the wager as is known in the gaming art.

If the player 13 has won the wager, then the amount of the winning wager is displayed on screen 41 as reflected as an addition to wagering account balance credit 18. The player 13 may continue to play as long as there is a sufficient balance shown on screen 41 to support the amount of the wager desired. Of course, additional amounts may be added to the player's account through cash, TITO voucher 32 or other means as described with respect to a disclosed embodiment. In one embodiment, a successful WIN ticket 31 may be inserted into optical mark recognition device 38 (OMR) to fund a wager. When player 13 has determined to end the gaming session, he or she may depress one of buttons 45 designated for that purpose or input an instruction through keypad 43 or touchscreen 41 in order to end that gaming session.

In one embodiment, ending the gaming session by player 13 results in the account balance being retained in the player wagering or loyalty account as reflected on screen 41. In another embodiment, ending of the gaming session by player 13 may result in the dispensing of a TITO voucher 32 at printer 47 depending upon player preference. In this embodiment, the amount of the account balance on screen 41 is reflected on TITO voucher 32. As will be further discussed below, TITO voucher 32 may be used at another gaming machine in the gaming establishment or at another type of gaming venue in that gaming establishment or in a gaming venue at another geographically remote gaming establishment.

In an alternate embodiment, referring again to FIG. 1, player 13 may use a TITO voucher 32 received from another type of gaming such as a slot machine 39 described in FIG. 3 or received from another kiosk 11 at another location in the gaming establishment to fund a sports wager at kiosk 11. Voucher 32 is inserted into bill acceptor/validator 37 which is then read and the player's wagering or loyalty account is credited. In another embodiment, if player 13 has a successful WIN ticket 31 from a successful sports book wager, he or she may insert that WIN ticket 31 into optical mark recognition device (OMR) 38 to fund his or her wagering account which may then be used to place another wager. If the player is unrated or anonymous the WIN ticket amount may be used to fund a wager directly. Of course, player 13 could also insert cash 30 into bill acceptor 37 or coin acceptor 35 to establish a wagering credit amount for wagering or to fund a wagering account if he is an account holder. In either event, as with the embodiments described in FIG. 2 and in the previous paragraph, player 13 is issued a WIN ticket 31 from printer 48 indicating the wager (#2 Tiger) and the amount of the wager (one hundred dollars).

Kiosk 11 provides flexibility of remote placement and 24/7/365 self-service to give the player 13 around-the-clock access for all race and sports book and account wagering needs and expands the market reach of the gaming establishment. In addition, players 13 will not be impacted by hours of operation in the sports book nor long lines at the counter 27. Kiosk 11 also provides a player the ability to sign up and create a new wagering or loyalty account in an interactive video conference mode as will be described further. Player 13 is able to add funds to his or her wagering account by inputting cash, TITO instruments 32 and winning WIN tickets 31 into the kiosk 11 as described above. Winning account wagers are paid directly to the player's sports wagering or loyalty account or through TITO vouchers 32 if the player so desires or if the player does not have a sports wagering or loyalty account.

In order to sign up for a player loyalty account card or a sports wagering account, player 13 may interact with kiosk 11 and gaming establishment personnel through keypad 14, screen 15 and/or telephone handset 16. That is, player 13 may verbally interact with a solution center employee of the casino establishment who is at another location on or off the casino premises. That employee may be pictured or represented by an image 17 on screen 15. Player 13 approaches kiosk 11 and follows a prompt on screen 15 to either login as an existing account holder or to sign up to open a new wagering account or to sign up for a player account card 29. In the event a new account is to be opened, the player is prompted through screen 15 or verbally by speaking through telephone handset 16, to input his or her name using keypad 14 or touchscreen 15. The player may then be asked, either verbally through handset 16 or visually through screen 15, or both, for certain personal information such as name, address, date of birth, social security number, driver's license number etc. The player may be asked to validate his or her identity by inserting his or her driver's license or other acceptable identification (e.g. passport, check cashing card etc.) into scanner reader 33 which may sense the authenticity of the inserted driver's license or other identification and validate information associated therewith. Scanner reader 33 may scan both sides of the driver's license or other identification to validate the information. Once all relevant information has been entered and validated, the player 13 is issued a sports account information ticket with a user ID and wagering rules printout as may be required in certain gaming jurisdictions from printer 48. In one embodiment, if player 13 has enrolled in the gaming establishment player loyalty program, he may be issued a player loyalty card from card reader/dispenser 33.

The availability of a kiosk providing self-service race and sports book as well as sign up for a race/sports wagering account and/or player loyalty card provides benefits to both patrons and sports book operations. Players may easily move from playing slot machines or other gaming types to sports book wagering utilizing kiosk 11. In one embodiment, TITO tickets 32 and winning race/sports WIN tickets 31 may be usable at the kiosk and over-the-counter in the race/sports book to place wagers. Kiosk 11 may or may not dispense cash in various embodiments. In an embodiment in which kiosk 11 does not dispense cash, TITO tickets 32 may be issued in lieu of cash which can then be redeemed in ticket redemption machines or at a cashier's cage or over the counter in the gaming establishment. TITO tickets 32 can be used to place sports wagers at the kiosk and/or fund player's wagering accounts. Even if kiosk 11 does dispense cash, player 13 may choose to have TITO ticket 32 dispensed in lieu of cash for personal or convenience reasons. A distinctive feature of the kiosk 11 is the manner in which sports book and gaming machine players will be brought closer together. By expanding the options in which players can interact with, and fund wagers on, gaming machines and race and sports books via wagering account balances, TITO instruments 32, and WIN tickets 31, players 13 will have a convenient wagering experience. Players 13 will be provided with a distinctive and easy way to wager in a near cashless manner across multiple types of gaming.

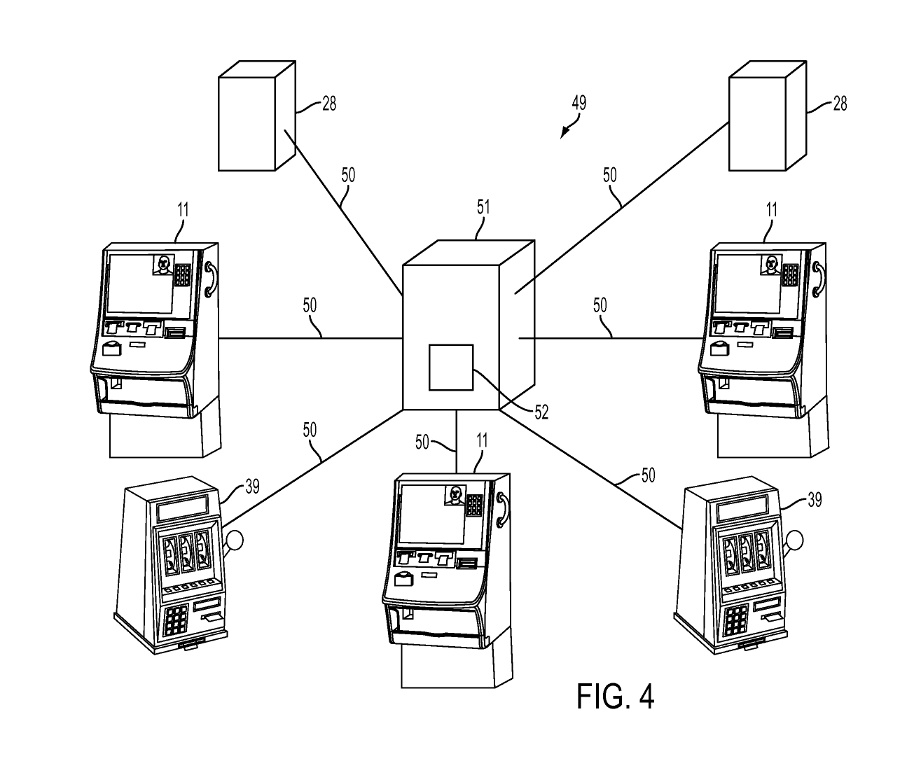

Referring to FIG. 4, a diagram of a gaming system network 49 is shown. A central computer 51 is shown electromagnetically connected at 50 to one or more kiosks 11 and various gaming machines 39 and one or more terminals 28. The devices connected to computer 51 are illustrative only, and for example, additional terminals at cashier's cages or at other gaming, restaurant or entertainment venues within or outside of the gaming establishment may be connected to computer 51 as is known in the art. The connections may be wired, wireless, optical or any other electromagnetic connection as is known in the networking art. Computer 51 includes a central database 52 which may contain player identity, player identification number, points balance, and account balance as well as any other relevant information for player loyalty accounts and wagering accounts. In one embodiment, database 52 may include race/sports information as displayed on screen 23 at sports book 22. When a player interacts with kiosk 11, all information is saved on central database 52 in computer 51. All interactions with, and information provided to, player 13 is provided through computer 51. In addition, information about player usage of slot machines or any other gaming machines such as video poker and the like may be saved in computer 51. This information may include time spent playing various machines as well as frequency of use of such machines as well as amounts won or lost in various wagers in any gaming venue (sports/machine/table).

Player usage of sports book venues 22 may be provided by terminals 28 at sports book venues. For example, when a player card 29 is inserted into terminal 28, or when a sports wagering account is accessed, and a wager is placed, that information may be recorded in central database 52 such that it may be determined how often and how much wagering is done by player 13 at sports book 22. The wagering history including win/loss history may also be included. The usage information retained by central database 52 is used to determine the player reward points accumulated by player 13 and thus player rewards such as VIP status at various venues (hotel, restaurants etc.) within the gaming establishment may be determined. In addition a player's sports wagering account keeps records of the amount and types of wagers made, and whether or not they were successful, as well as the amounts wagered. This permits player 13 to access this information for reference purposes. In this way, both the gaming establishment and the player 13 may benefit from this information.

While terminals 28 have been shown as being placed in a sports book venue 22, it should be expressly understood that these terminals 28 may be placed at various locations on or off the premises of the gaming establishment. For example, terminals 28 could be placed in the cashier's cage at the gaming establishment such that, when a player 13 purchases, for example, playing chips to be wagered at a table game such as blackjack, roulette, baccarat or the like, such information is communicated to central database 52 such that the player wagering account reflects the level of play of that player 13. In one embodiment, player 13 may access his wagering or loyalty account at various gaming venues and make withdrawals in the form of gaming chips, cash or credits at gaming machines. Similarly, terminals 28 could be located in various restaurants in the gaming establishment to allow player 13 to access his player loyalty account by inserting loyalty card 29 or swiping it at terminal 28. Because of the information saved in database 52 is collected based upon the scanning of player card 29, terminals 28 at hotels or restaurants in the gaming establishment could provide additional possibilities for player 13 to add points to or redeem points from, his or her player loyalty card account balance or to purchase goods and services from his or her loyalty card account balance either with accumulated points or, in one embodiment, with a dollar balance in the account.

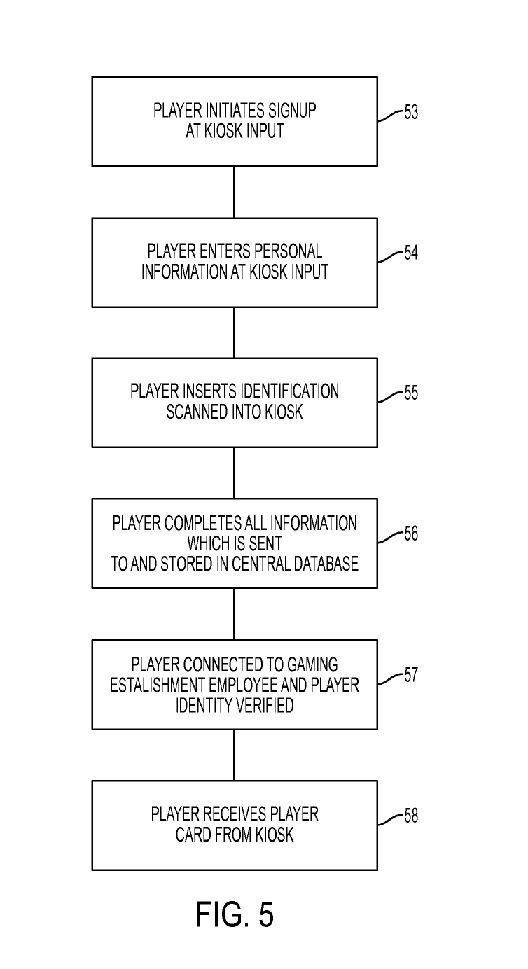

Referring to FIG. 5, in one embodiment a flow chart of a player loyalty card account signup process is shown. At step 53, player 13 approaches kiosk 11 and indicates on kiosk 11 that he or she wishes to sign up for a player loyalty account card 29. This may be done by a touch screen icon on display screen 15 or by pressing a key on keypad 14 designated as a new account start up key. Upon pressing the key, at step 54, player 13 is prompted by central computer 51 in the network 49, to input his or her name and various other pertinent information such as an address, birthdate, desired PIN number etc. required to open the account. In one embodiment, at step 55, player 13 inserts his or her driver's license or other form of identification as discussed above into reader/scanner 33 in kiosk 11 to have the player's identity validated. The player's information, including the validated ID, is communicated to central computer 51 and stored in database 52 at step 56. The information entered is summarized on screen 15 and player 13 is prompted to verify the information and push a “submit” key on touchscreen 15 or keypad 14. Player 13 is then prompted to pick up telephone receiver 16 and is connected to a gaming establishment employee located in a customer solution center at step 57. The face of the employee is shown on screen 17 which is part of touchscreen 15. Player 13 is audibly connected to the employee by receiver 16 and visually by video or still camera 20 on kiosk 11 which transmits the image of player 13 to the employee through network 49 such that player 13's identity can be verified against the driver's license or other identification submitted by player 13 through reader/scanner 33. At step 58, in another embodiment, player 13 receives a player loyalty card 29 from card reader/dispenser 33.

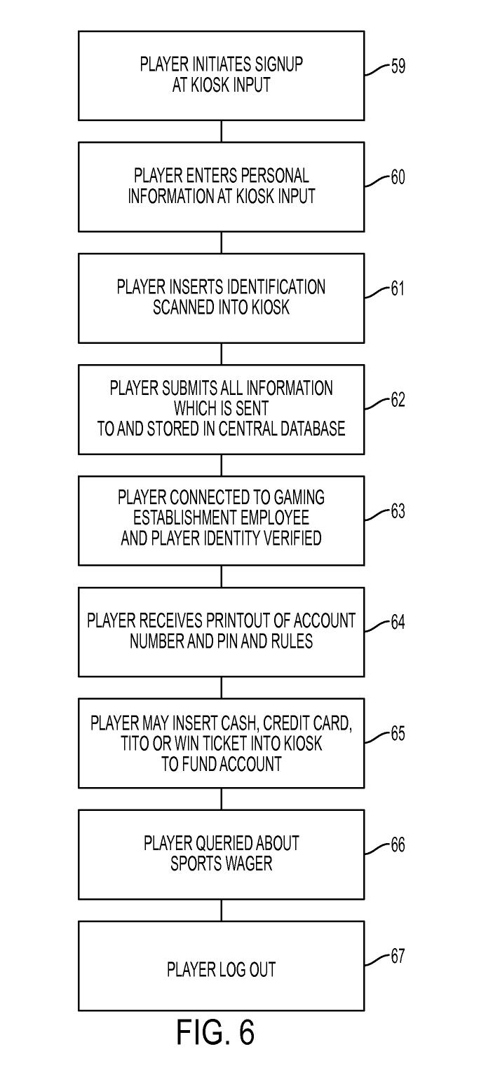

Referring to FIG. 6, in one embodiment a flow chart of a player signup process for a race/sports book wagering or player loyalty account is shown. At step 59, player 13 approaches kiosk 11 and initiates a signup process for the wagering account. This may be achieved by touching a screen icon on touchscreen 15 or by pressing a key on keypad 14 designated as a wagering account startup key. In one embodiment, a wagering account requires that player 13 have an existing loyalty account in order to sign up for a wagering account. Player 13 is then prompted at step 60 to enter certain personal information such as name, address, date of birth, social security number, telephone number etc. At step 61, player 13 is prompted to insert ID verification, such as, for example, a driver's license, into card reader/scanner 33. The information entered is summarized on screen 15 and player 13 is prompted to verify the information and push a “submit” key on touchscreen 15 or keypad 14 at step 62. Player 13 is then prompted to pick up telephone receiver 16 and is connected to a gaming establishment employee at step 63. The face of the employee is shown on screen 17 which is part of touchscreen 15. Player 13 is audibly connected to the employee by receiver 16 and visually by video or still camera 20 on kiosk 11 which transmits the image of player 13 to the employee through network 49 such that player 13's identity can be verified against the driver's license or other identification submitted by player 13 through scanner 33.

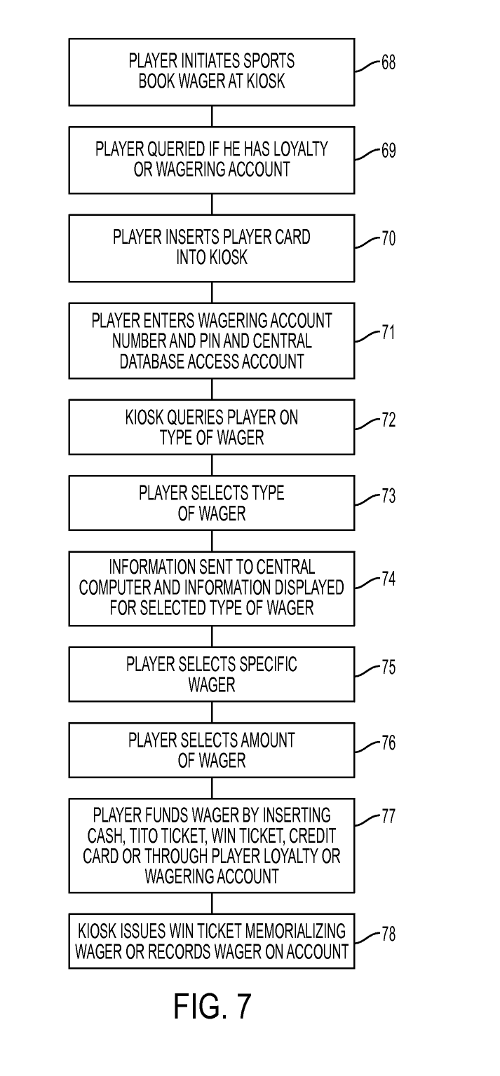

Once player information and identity is verified, the wagering account is opened and player 13 receives a printout of the rules associated with a wagering account and a sports wagering account ticket with user identification and PIN number through printer 48 at step 64. In one embodiment, at step 65, player 13 is prompted and indicates whether or not he or she wishes to fund their account by inserting cash, TITO voucher 32 or successful WIN tickets 31, or a credit card into kiosk 11. In another embodiment, at step 66, player 13 may be asked whether or not he or she wishes to place a sports wager as will be described below with respect to FIG. 7. Upon completion of the appropriate or desired steps and if a sports wager is not desired, player 13 may log out at step 67 and may leave the kiosk venue.

Referring to FIG. 7, a flow chart illustrating a sports betting sequence at kiosk 11 is shown in one embodiment. At step 68, player 13 approaches kiosk 11 and indicates on kiosk 11 that he or she wishes to place a sports wager on kiosk 11. This may be done by a touch screen icon on display screen 15 as is known in the art or by pressing a key on keypad 14 designated as a sports wagering key. In one embodiment, upon pressing the key or icon to make a sports wager, at step 69, player 13 is queried on touchscreen 15 as to whether player 13 has either a player loyalty account and/or a race sports wagering account. If player 13 indicates that he or she does have such a loyalty account then, at step 70 he inserts his player loyalty card 29 into reader 33. If player 13 also has a sports wagering account and desires to wager using that account, then, upon completion of step 70, at step 71 he or she is prompted to input his or her race/sports account number and PIN using touchscreen 15 or keypad 14. Player 13 then proceeds to step 72. Player 13 is considered unrated/anonymous if he does not have a loyalty card 29 which may or may not include an associated sports wagering account. If player 13 is unrated/anonymous (does not have a loyalty account or associated sports wagering account) and wishes to place a wager, then, at step 69, he or she indicates such and proceeds directly to step 72. At step 71, upon reading player card 29 and/or the inputted sports wagering account number and PIN, that information is sent to central computer 51 which accesses player information in central database 52. Upon successful completion of step 71, the player's information 18 including name, rewards points balance and/or wagering account balance is displayed on screen 15.

After step 71, or if player 13 is unrated/anonymous, then after step 69, player 13 is prompted to indicate the type of sports wager he or she wishes to make at step 72. At step 73, the player 13 indicates, through keypad 14 or touch screen 15 icon, whether he or she wishes to make a wager on a horse race, a sports game such as a football game, baseball game, basketball game or other event as is known in the gaming arts. If, for example, player 13 indicates that he or she wishes to place a wager on, for example, a football game, then, at step 74 central computer 51 receives this information and presents information on screen 15 of kiosk 11 identical to that discussed above on screen 23 at sports book 22 in FIG. 2.

At step 75, player 13 selects, through keypad 14 or a touch screen 15 icon, that, in the case of the Lions and Tigers game example discussed above, he or she wishes to wager on #2 (Tigers). At step 76, player 13 is prompted to enter (again through keypad 14 or a touch screen icon) the amount of the wager which, in this example, is for one hundred dollars. In one embodiment, player 13 is then prompted in step 77, whether he or she wishes to fund this one hundred dollar wager through cash, from his or her wagering account balance, from a TITO ticket voucher 32, from a successful WIN ticket 31, or, in one embodiment, by player loyalty, credit, or debit card. Depending upon the player selection, he or she inputs the selected cash or ticket or card into kiosk 11 to fund the wager or indicates through keypad 14 that he or she wishes the wagered amount to be deducted from his or her account. At step 78, kiosk 11 may issue a WIN ticket 31 to player 13 through printer 48 indicating that a wager in the amount of one hundred dollars has been made on the Tigers minus 3 points or if the player has a wagering or loyalty account, he may elect not to receive a WIN ticket but rather have the wager recorded on his account. In this same manner, player 13 may make multiple sports book wagers through kiosk 11.

Successful WIN tickets 31 and TITO vouchers 32, printed by printer 48 from kiosk 11 may be redeemed at different types of gaming venues or at cashier's cages or other redemption centers in the gaming establishment. Thus, player 13 is permitted to both establish a race/sports wagering account and enroll in a player loyalty program as well as to make a sports book wager at kiosk 11. Player 13 may make a sports wager without the need for casino employee involvement and thus added convenience to the player as well as reduced staffing requirements on the part of the gaming establishment may be achieved. Player 13 may avoid lines at race/sports book counter 27 and may place sports book wagers more quickly, thereby avoiding a situation where the start of an event precludes placing a wager because the line is too long at a sports book venue such as that described in FIG. 2. In addition, because the availability of the kiosk is 24/7/365, the benefit to the casino of increased player participation in both the wagering account and player loyalty programs as well as the increased wagering on sports book may be achieved.

While the disclosure has described various embodiments, it should be expressly understood to those of ordinary skill in the art that certain modifications may be made without departing from the spirit or scope of this disclosure. For example, while various network configurations and connections have been disclosed it should be understood that alternate configurations and connections may be employed without departing from the spirit or scope of the disclosure. Accordingly, the proper scope of this disclosure is set forth in the following claims.

1-10. (canceled)

11. Method for a player to enroll in a wagering account on an interactive kiosk located on the premises of a gaming establishment, said kiosk including a processor electronically connected to a central database, said method comprising the steps of:
prompting a player to enter personal information into said kiosk;
accepting said personal information at said kiosk;
sending said information from said processor to said central database;
recording said information in said central database;
interactively connecting said player to a gaming establishment employee through an audiovisual connection on said kiosk;
establishing a wagering account based, at least in part, upon said personal information and an indication of a visual verification of said player by said employee; and
providing information associated with said account from said kiosk to said player.

12. The method according to claim 11 wherein said step of recording information includes:
inserting said player's driver's license into said kiosk; and validating said driver's license.

13. The method according to claim 11 further including the step of funding said wagering account through said kiosk.

14. The method according to claim 13 wherein said step of funding includes inserting a WIN ticket into said kiosk.

15. The method according to claim 13 wherein said step of funding includes inserting cash into said kiosk.

16. The method according to claim 13 wherein said step of funding includes inserting a credit or debit card into said kiosk.

17. The method according to claim 13 wherein said step of funding includes inserting a TITO voucher into said kiosk.

18. The method of claim 11 further including querying said player as to whether the player wishes to place a wager.

19.-30. (canceled)

31. Method for a player to enroll in a wagering account on an interactive kiosk, said kiosk including a processor electronically connected to a central database, said method comprising the steps of:
initiating a signup process on said kiosk;
entering loyalty account information;
prompting a player to enter personal information into said kiosk;
requiring said player to verify said personal information;
sending said verified information from said processor to said central database;
interactively connecting said player to a gaming establishment employee through an audiovisual connection on said kiosk;
establishing a wagering account based upon said verified personal information and visual verification of said player through said audiovisual connection.

32. The method of claim 31 wherein said step of initiating includes touching a touchscreen.

33. The method of claim 31 wherein said step of initiating includes touching a keypad.

34. The method of claim 31 wherein said step of verifying said personal information includes scanning an identification validation document of a player.

35. The method of claim 34 wherein said identification document includes a passport.

36. The method of claim 34 wherein said identification document includes a driver's license.

37. The method of claim 31 further including recording said verified information in a central database.

38. The method of claim 31 further including funding said wagering account.

39. The method according to claim 38 wherein said step of funding includes inserting a WIN ticket into said kiosk.

40. The method according to claim 38 wherein said step of funding includes inserting cash into said kiosk.

41. The method according to claim 38 wherein said step of funding includes inserting a credit or debit card into said kiosk.

42. The method according to claim 38 wherein said step of funding includes inserting a TITO voucher into said kiosk.

43. The method of claim 31 further including querying said player as to whether the player wishes to place a wager.
